(19) United States
(12) Patent Application Publication
(10) Pub. No.: US 2026/0332702 A1
(43) Pub. Date: Oct. 22, 2026

(54) SYSTEM AND METHOD FOR RESUMING A DISCONNECTED INBOUND-INTERACTION BETWEEN AN AGENT AND A CUSTOMER IN A CONTACT CENTER

(71) Applicant: NICE LTD., Ra'anana (IL)

(72) Inventors: Susmith ROY, Cachar (IN); Hugh SMITH, Box Hill (AU); Basavraj GHULI, Pune (IN)

(21) Appl. No.: 19/185,314

(22) Filed: Apr. 22, 2025

(51) Int. Cl. H04M 3/51; G06Q 10/0631; H04M 3/523

(52) U.S. Cl. CPC H04M 3/5166; G06Q 10/063112; H04M 3/5233; H04M 2201/42; H04M 2203/401; H04M 2203/403

(57) ABSTRACT

A computerized-method for ranking and connecting a consultant to an agent during an interaction to aid the agent in a contact center. The computerized-method includes: (i) receiving a disposition from a first agent during ACW of the first interaction, that included a consultation with a consultant, via a UI. The disposition includes rating and badging of the consultant and an associated subject-matter entered by the first customer via an IVR menu; (ii) saving the rating and badging of the consultant and the associated subject-matter, in an address-book; and (iii) configuring a WFM application to connect in real-time a second agent with a second consultant during a second interaction with a second customer, upon the second agent user-click on a consultant-button via the UI. The second consultant is selected from the address-book based on the highest rating for the subject-matter entered by the second customer via the IVR menu.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records but otherwise reserves all copyright rights whatsoever.

### TECHNICAL FIELD

The present disclosure relates to the field of computerized systems and methods for ranking and connecting a consultant to an agent during an interaction to aid the agent in a contact center.

### BACKGROUND

In contact centers, during calls with customers, the agents often reach out to Subject Matter Experts (SME)s for consultation. Typically, the agents look for SME groups or teams in an address book. From the available SME list in the address book, the agents search for knowledgeable SMEs for the consultation.

As of today, there is no way for agents to know which SME is more knowledgeable for the consultation than the others. For example, if the agent wants to know which SMEs are rated 4.5 and above on a scale of 1 to 5. Along with the rating of the SME, it may be beneficial for the agent to know the SME's highly appreciated skill or badge, such that the agent would be in a better position to decide which SME to choose for the consultation before the agent is initiating it.

In the omni-channel contact center, where the agent consults with SMEs and consultants from the business unit, there is a need for a technical solution that will provide rating of the consultation they received, to help the agent community know which SME has better knowledge based on the ranking.

There is a need for system and method for ranking and connecting a consultant to an agent during an interaction to aid the agent in a contact center.

### SUMMARY

There is thus provided, in accordance with some embodiments of the present disclosure, a computerized-method for ranking and connecting a consultant to an agent during an interaction to aid the agent in a contact center.

In accordance with some embodiments of the present disclosure, the computerized-method may include: (i) receiving a disposition from a first agent during After Call Work (ACW) of a first interaction between the first agent and a first customer, that included a consultation with a consultant from a plurality of consultants, via a User Interface (UI) that is associated to an agent application. The disposition may include rating and badging of the consultant and an associated subject-matter entered by the first customer via an Interactive Voice Response (IVR) menu; (ii) saving the rating and badging of the consultant and the associated subject-matter, in an address-book; and (iii) configuring a Workforce Management (WFM) application to automatically connect in real-time a second agent with a second consultant during a second interaction with a second customer, upon the second agent user-click on a consultant-button via the UI. The second consultant may be selected from the plurality of consultants in the address-book based on a highest rating for the subject-matter entered by the second customer via the IVR menu.

Furthermore, in accordance with some embodiments of the present disclosure, the rating is based on a skill set of the consultant and the skill set is related to the entered subject-matter.

Furthermore, in accordance with some embodiments of the present disclosure, the rating of the consultant is captured by a rating and badging capturing service.

Furthermore, in accordance with some embodiments of the present disclosure, the saving of the rating and badging of the consultant may include operating a rating module and a badge module.

Furthermore, in accordance with some embodiments of the present disclosure, the WFM application may schedule consultants having the rating above a first preconfigured rate-threshold during forecasted time-slots with volume above a preconfigured volume-threshold.

Furthermore, in accordance with some embodiments of the present disclosure, consultants having the rating below a second rate-threshold may be automatically assigned to a training session.

Furthermore, in accordance with some embodiments of the present disclosure, the computerized-method may further include configuring a Quality Management (QM) application to sample interactions for audit based on the rating of the consultant.

There is further provided, in accordance with some embodiments of the present invention, a computerized-system for ranking and connecting a consultant to an agent during an interaction to aid the agent in contact center.

Furthermore, in accordance with some embodiments of the present disclosure, the computerized-system may include: a User Interface (UI) associated to an agent application; an Interactive Voice Response (IVR) menu; an address-book of a plurality of consultants; a memory to store the address-book; and one or more processors.

Furthermore, in accordance with some embodiments of the present disclosure, the one or more processors may be configured to: (i) receive a disposition from an agent during After Call Work (ACW) of a first interaction between a first agent and a first customer, that included a consultation with a consultant from a plurality of consultants, via the UI that is associated to the agent application. The disposition is comprising rating and badging of the consultant and an associated subject-matter entered by the first customer via an Interactive voice response (IVR) menu; (ii) saving the rating and badging of the consultant and the associated subject-matter, in the address-book; and (iii) configuring a Workforce Management (WFM) application to automatically connect in real-time a second agent with a second consultant during a second interaction with a second customer, upon the second agent user-click on a consultant-button via the UI. The second consultant may be selected from the plurality of consultants in the address-book based on a highest rating for the subject-matter entered by the second customer via the IVR menu.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIGS. 1A-1B schematically illustrates a high-level diagram of a computerized-system for ranking and connecting a consultant to an agent during an interaction to aid the agent in a contact center, in accordance with some embodiments of the present invention;

FIG. 2A schematically illustrates a high-level workflow of a computerized-method for receiving and saving the rating of the consultant and the associated subject-matter, in an address-book, in accordance with some embodiments of the present invention;

FIG. 2B is a table 200B of Bayesian Average to agent ranking dataset, in accordance with some embodiments of the present invention;

FIG. 3 schematically illustrates a high-level workflow of a computerized-method for receiving and saving the badging of the consultant and the associated subject-matter, in an address-book, in accordance with some embodiments of the present invention;

FIG. 4 schematically illustrates a high-level workflow of a computerized-method for ranking and connecting a consultant to an agent during an interaction to aid the agent in a contact center, in accordance with some embodiments of the present invention;

FIG. 5 schematically illustrates a high-level diagram of computerized-system for ranking and connecting a consultant to an agent during an interaction to aid the agent in a contact center, in a contact center, in accordance with some embodiments of the present invention;

FIG. 6 schematically illustrates a high-level workflow of SME feedback collector module, in a contact center, in accordance with some embodiments of the present invention;

FIG. 7 schematically illustrates a high-level workflow of SME lookup module, in a contact center, in accordance with some embodiments of the present invention;

FIG. 8 schematically illustrates a high-level diagram of computerized-system for ranking and connecting a consultant to an agent during an interaction to aid the agent in a contact center, in a contact center, in accordance with some embodiments of the present invention;

FIG. 9 schematically illustrates a hardware architecture of computerized-system for ranking and connecting a consultant to an agent during an interaction to aid the agent in a contact center, in accordance with some embodiments of the present invention;

FIG. 10 is a screenshot of a UI page of an agent application for ranking and badging a consultant, in a contact center in accordance with some embodiments of the present invention;

FIG. 11 schematically illustrates a software architecture of computerized-system for ranking and connecting a consultant to an agent during an interaction to aid the agent in a contact center, in accordance with some embodiments of the present invention;

FIG. 12 is a screenshot of a UI page of an agent application with ranking and badging of a consultant, in a contact center, in accordance with some embodiments of the present invention.

FIG. 13 schematically illustrates a high-level workflow of ACD routing based on ranking and badging of a consultant, in accordance with some embodiments of the present invention;

FIG. 14 schematically illustrates a high-level workflow of WFM scheduling based on ranking and badging of a consultant, in accordance with some embodiments of the present invention;

FIG. 15 schematically illustrates a high-level workflow of QM application filtering of interactions based on ranking and badging of a consultant, in accordance with some embodiments of the present invention;

FIG. 16 schematically illustrates a high-level workflow of learning and development based on ranking and badging of a consultant, in accordance with some embodiments of the present invention;

FIG. 17 schematically illustrates a high-level workflow of performance analytics and reporting based on ranking and badging of a consultant, in accordance with some embodiments of the present invention; and

FIG. 18 is a screenshot of a UI page of an agent application with badging of consultants, in a contact center, in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

As used herein, the term “ranking” refers to rating and the term “rank” refers to “rate”.

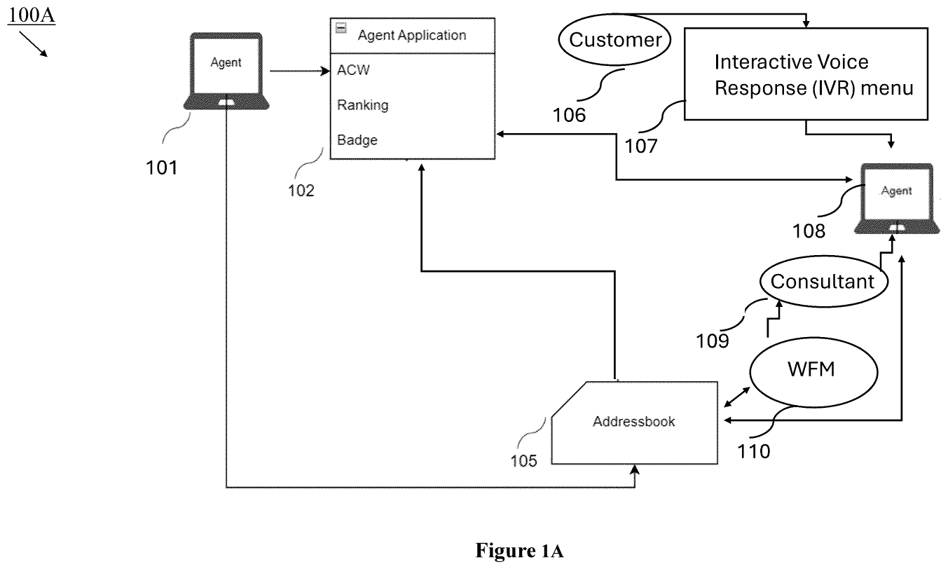

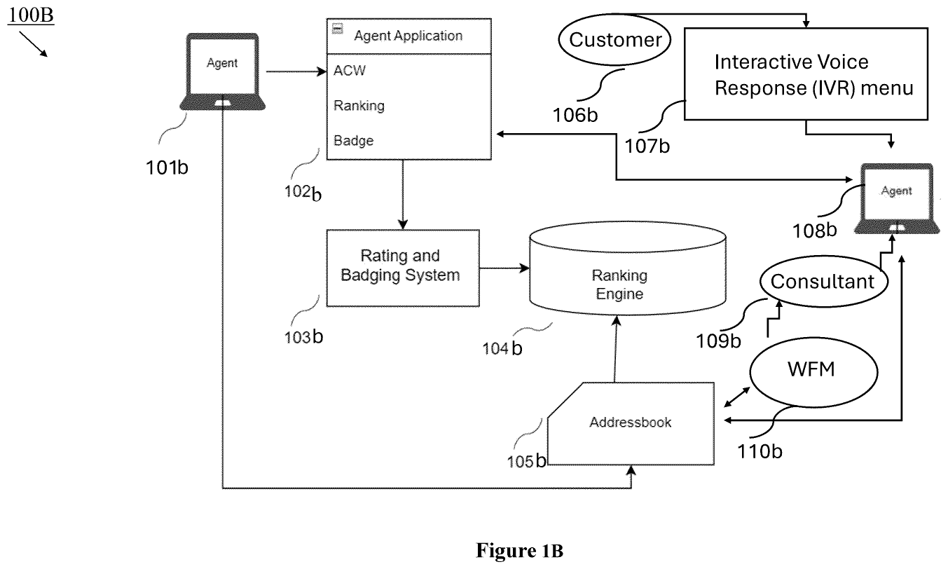

FIG. 1A schematically illustrates a high-level diagram of a computerized-system 100A for ranking and connecting a consultant to an agent during an interaction to aid the agent in a contact center, in accordance with some embodiments of the present invention.

According to some embodiments of the present disclosure, in a system, such as computerized-system 100A an agent 101 during an interaction with a patron or a customer may require the assistance of a consultant, such as a Subject Matter Expert (SME) for consultation. Post completion of the consultation and wrapping up the call with patron, agent gets into After Call Work (ACW) mode.

According to some embodiments of the present disclosure, the purpose of ACW is to wrap up the call and update the case or fill up the disposition form and if needed create a task to follow up. As part of this ACW state, the agent 101 may be given an option to update the ranking to the service of the consultant that the agent received from the SME for the consultation and provide a related badge.

According to some embodiments of the present disclosure, the update may be operated via a User Interface (UI) of an agent application 102. The ranking and badging system may pull the existing rank value and badge list for the respective SME. The average of new rank value and old rank value may be stored into the database of the address-book 105.

According to some embodiments of the present disclosure, an address-book service, such as rating and badging system 103b in FIG. 1B may keep polling for this data from the database, such that the address-book has the latest rank value and badge list for each consultant.

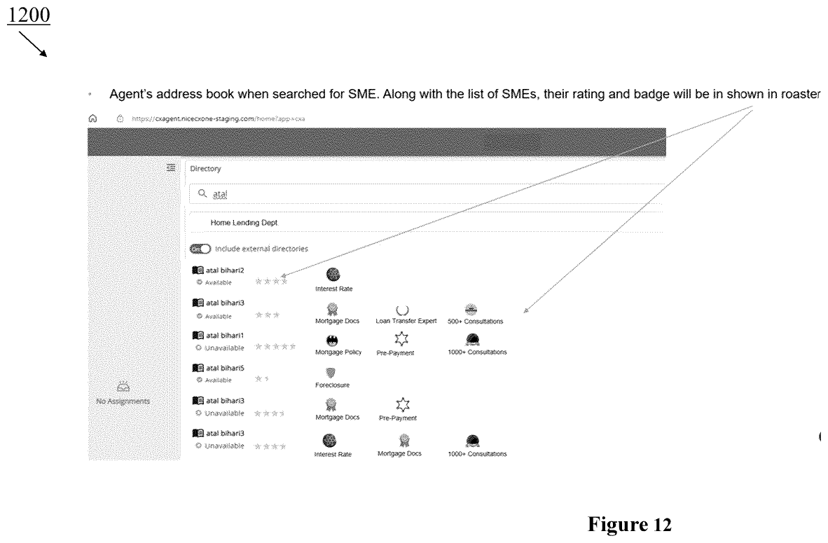

According to some embodiments of the present disclosure, when an agent may require consultant assistance during an interaction, the agent may be automatically connected to a consultant having highest rating or optionally, the agent may look up the rank value and badge along with other details of each SME like first name, last name and the like in the address-book 105. For example, as shown in FIG. 12.

According to some embodiments of the present disclosure, a system, such as computerized-system 100A may receive a disposition from an agent 101 during After Call Work (ACW) of an interaction between the agent and a customer, that included a consultation with a consultant from a plurality of consultants, via a User Interface (UI) that is associated to an agent application 102. At the end of the interaction, the agent may submit the disposition for the interaction. In cases where the agent has consulted a consultant Subject Matter Expert (SME) during the interaction, computerized-system 100A may require, via the UI of the agent application 102 for the SME rating, e.g., on a scale or as the star and require for award in the form of a badge to the SME for the skill.

According to some embodiments of the present disclosure, for example, when an inbound call is answered by an agent from home leading skill and the patron is asking various questions, e.g., offered by the mortgage house which require SME assistance, the agent looks up the address-book of consultants in the mortgage department. Then, the agent selects a consultant and engages in conversation with SME via a communication channel, such as voice, chat and the like. Based on the information received from SME, the agent may respond to the patron's questions.

According to some embodiments of the present disclosure, as part of the disposition, the agent is provided by the agent application 102 the option to rate the SME consultation service. The consultant may be ranked on a scale of 1-5 and provided a badge for the skill, like mortgage, lending rate, product name etc. The collected rating and badging may be forwarded to a rating and badging system 103 and then averaged with the historical data of SMEs by a ranking engine 104 and stored in the database of the address-book 105.

According to some embodiments of the present disclosure, the rating and badging of the consultant and the associated subject-matter may be stored in the database of the address-book 105.

According to some embodiments of the present disclosure, when another agent 108 may have an interaction with a customer 106 the agent 108 may search for an SME in the home lending department, the highest ranked consultant may be automatically connected to the agent or alternatively, the agent 108 may see the ranking of the SME and badge against the SME name among other consultants. Based on the ranking and the badges of the consultants, the agent 108 can decide which SME has prior experience in solving similar questions. Also, the rank order would provide knowledge of the SME in that domain or subject matter.

According to some embodiments of the present disclosure, the highest ranked consultant may be automatically selected and connected to the agent based on the subject matter entered by the customer via an Interactive Voice Response (IVR) menu 107. The subject-matter may be associated to the SME.

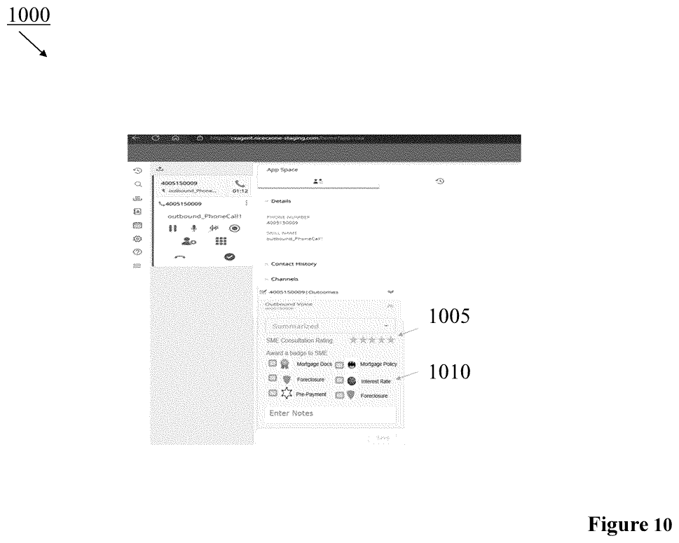

According to some embodiments of the present disclosure, a Workforce Management (WFM) application 110 may be configured to automatically connect in real-time the agent 108 with a consultant 109 during the interaction with the customer, upon the agent user-click on a consultant-button via the UI of the agent application 102. For example, as shown in FIG. 10. The consultant 109 may be selected from the plurality of consultants in the address-book 105 based on a highest rating for the subject-matter entered by the customer 106 via the IVR menu 107.

According to some embodiments of the present disclosure, with the consultant automatically connected to the agent via a communication channel upon a consultant-button via the UI of the agent application 102 or the agent looks up in the address-book 105, computerized-system 100A may improve the Average Hold Time (AHT) of the agent and increase the agent performance during interactions.

According to some embodiments of the present disclosure, the rating may be based on a skill set of the consultant which may be related to the entered subject-matter via the IVR menu 107 by the customer.

According to some embodiments of the present disclosure, the saving of the rating and badging of the consultant comprising operating a rating module and a badge module.

According to some embodiments of the present disclosure, the WFM application 110 may be configured to schedule consultants having the rating above a preconfigured rate-threshold during forecasted time-slots with volume above a preconfigured volume-threshold.

According to some embodiments of the present disclosure, consultants having the rating below a rate-threshold may be automatically assigned to a training session.

FIG. 1B schematically illustrates a high-level diagram of a computerized-system 100B for ranking and connecting a consultant to an agent during an interaction to aid the agent in a contact center, in accordance with some embodiments of the present invention.

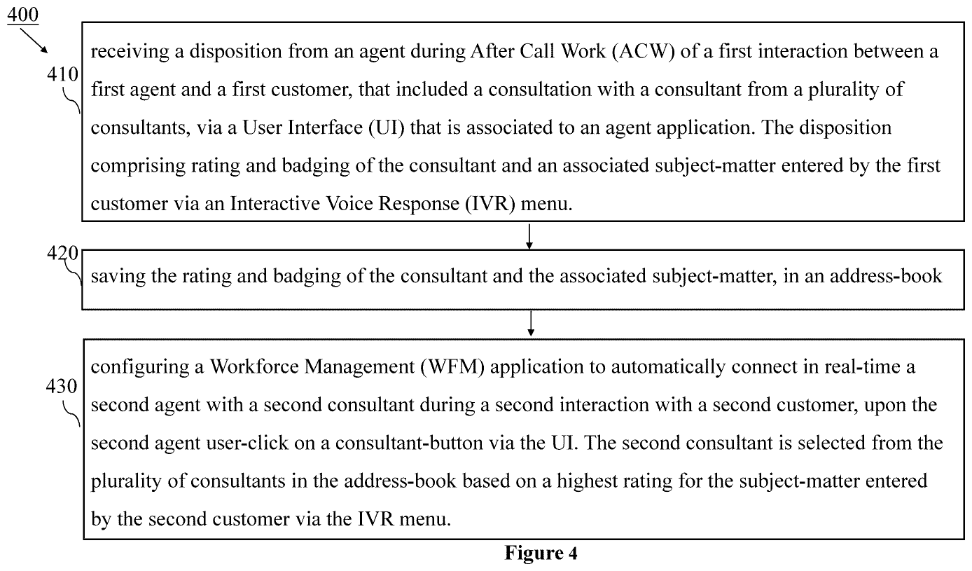

According to some embodiments of the present disclosure, computerized-system 100B has similar components as computerized-system 100A in FIG. 1A. Computerized-system 100B may implement computerized-method 400 in FIG. 4 for ranking and connecting a consultant to an agent during an interaction to aid the agent in a contact center.

According to some embodiments of the present disclosure, the rating of the consultant may be captured by a rating and badging capturing service, e.g. rating and badging system 103b that may be associated to the agent application 102b.

According to some embodiments of the present disclosure, the collected rating and badging may be forwarded to a rating and badging system 103b which may operate a rating module and a badge module to average the rating and the badge with the historical data of SMEs by using a ranking engine 104. The average rating and badge may be stored in the database of the address-book 105b.

According to some embodiments of the present disclosure, a Quality Management (QM) application may be configured to sample interactions for audit based on the rating of the consultant.

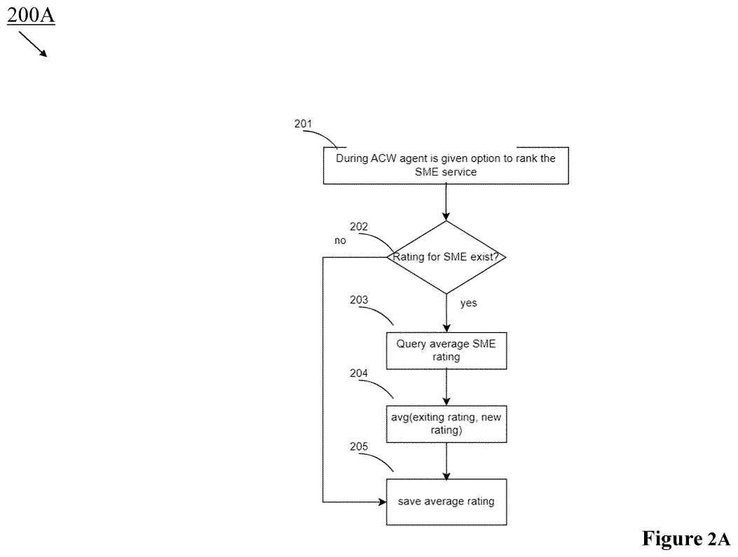

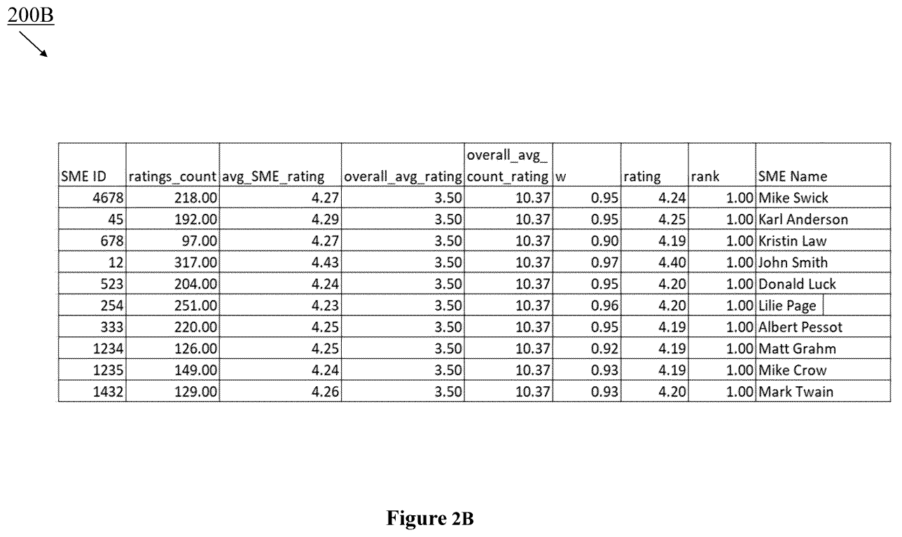

FIG. 2A schematically illustrates a high-level workflow of a computerized-method 200A for receiving and saving the rating of the consultant and the associated subject-matter, in an address-book, in accordance with some embodiments of the present invention.

According to some embodiments of the present disclosure, when an interaction is completed, the agent starts an ACW mode to update the disposition for the interaction the agent handled.

According to some embodiments of the present disclosure, in system 100A in FIG. 1A and in system 100B in FIG. 1B, in interactions that the agent has used the consultation from back-office SME or consultant then, during the ACW state the agent may be given an opportunity to provide ranking for the consultation agent received 201.

According to some embodiments of the present disclosure, checking if the SME has historic ranking or rating 202 and if the SME has historic ranking, then the new rating that has been entered by the agent during the ACW may be averaged 203 with the historic data. For example, cumulative rating of the new rating with the historic data may be operated by an averaging method, such as Bayesian-average of all the rating received for that SME.

According to some embodiments of the present disclosure, the average of existing rating in the historic data and the new rating 204 may be calculated, for example, according to formula I:

sᵢ=wᵢ·Aᵢ+(1−wᵢ)·S (I)

whereby:
w is the weight assigned to the item's arithmetic mean A, while S denotes the System's Arithmetic Mean. If both A and S are bound, then the final score s will also be bound within the same range.

According to some embodiments of the present disclosure, the average rating may be saved 205.

FIG. 2B is a table 200B of Bayesian average to agent ranking dataset, in accordance with some embodiments of the present invention.

According to some embodiments of the present disclosure, table 200B shows a Bayesian average for each SME which is the average SME rating and the number of the ratings. Instead of finding the average, the mean is calculated.

According to some embodiments of the present disclosure, the SME ID is a unique identifier for each SME. The ratings_count is the number of ratings received by each SME. Higher ratings counts may indicate more trust or interaction. The avg_SME_rating is the average rating given to each SME across all ratings they received.

According to some embodiments of the present disclosure, the overall_avg_rating: fixed or overall average rating across all SMEs or the system. In Bayesian terms, this is the prior or base rating before considering the SME's specific ratings. The count_rating: This represents the number of ratings used to calculate the overall_avg_rating.

According to some embodiments of the present disclosure, w is the weighting factor adjusts the influence of an SME's own average rating based on their number of ratings relative to the total or overall average. The rating is the final Bayesian-adjusted rating, which combines the SME's own average rating with the system's overall average, considering the number of ratings and the weighting. The rank is the rank of each SME based on their final Bayesian-adjusted rating. The SME Name is the name of the SME.

According to some embodiments of the present disclosure, the Bayesian average algorithm is a method for computing ratings, where SMEs are evaluated based on the consultations they provide. A basic rating system that takes the average of an SME's ratings can be misleading because it does not account for the number of ratings received. SMEs with fewer ratings might appear to have an inflated or deflated score simply due to statistical variance. The Bayesian approach addresses this by blending the SME's individual rating with the overall average rating across all SMEs, ensuring that the final rating is more stable and less prone to anomalies caused by limited data.

According to some embodiments of the present disclosure, the Bayesian average may be calculated based on formula II:
Bayesian Rating=(C*M+R*N)/(C+N)
   whereby:
R is the SME's average rating from individual reviews,
N is the number of ratings received by the SME,
M is the overall average rating across all SMEs which are stored in the address-book, and
C is a constant representing the minimum number of ratings required for an SME's rating to be considered statistically significant.

According to some embodiments of the present disclosure, in the dataset in table 200B, each SME has a different rating count and an average SME rating. If they were ranked based purely on the average SME rating, John Smith, SME ID 12 with a high rating of 4.43 would rank at the top, while others with slightly lower ratings but significantly more reviews, such as Lilie Page, with 251 ratings, 4.23 average, might be overlooked. However, the Bayesian model incorporates the total number of ratings into the equation, ensuring that an SME with very few ratings does not outrank an experienced SME simply due to a lack of sufficient data. The Bayesian weighted rating in column “rating” adjusts these values, as seen in John Smith's adjusted rating of 4.40 instead of his raw 4.43.

According to some embodiments of the present disclosure, the Bayesian average may be useful for ranking SMEs in a call center environment where consultation ratings can be subjective and influenced by the number of interactions. For instance, SMEs with high expertise but fewer ratings, due to handling niche queries, might otherwise rank lower than those handling a high volume of common issues. By using a Bayesian rating, the system, such as computerized-system 100B in FIG. 1B ensures that SMEs with fewer ratings are still considered without giving undue advantage to those with large but potentially inconsistent rating pools. In the dataset, SMEs like Kristin Law with 97 ratings, 4.27 average have their Bayesian rating adjusted downwards to 4.19 to balance against the overall average rating of 3.50.

According to some embodiments of the present disclosure, the Bayesian average algorithm provides a balanced ranking system that prevents manipulation or misrepresentation due to low data volume. It ensures that SMEs who have been rated more frequently get rankings closer to their actual average, while those with fewer ratings are weighted towards the overall SME population average. This approach is highly effective in ranking back-office SMEs in a contact center, to automatically connect to a highest ranked consultant or to identify reliable experts while ensuring that newer or less-rated SMEs are still given a fair chance to establish their credibility.

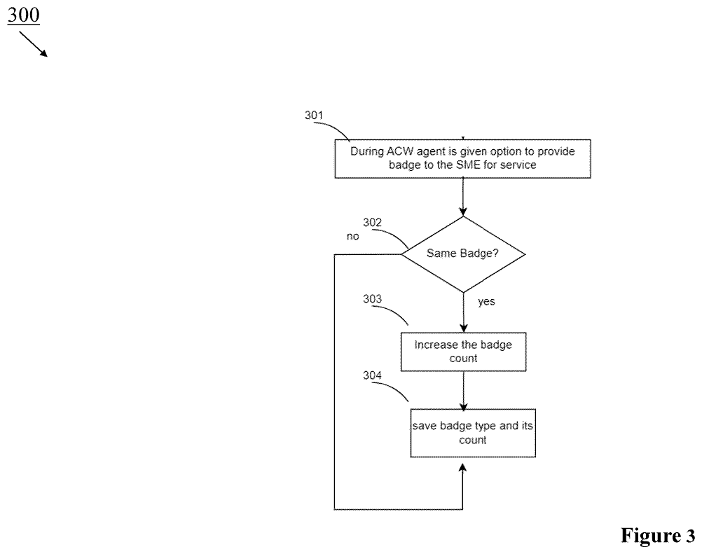

FIG. 3 schematically illustrates a high-level workflow 300 of a computerized-method for receiving and saving the badging of the consultant and the associated subject-matter, in an address-book, in accordance with some embodiments of the present invention.

According to some embodiments of the present disclosure, when an interaction is completed, the agent gets in ACW mode to update the disposition for the interaction the agent handled.

According to some embodiments of the present disclosure, in system 100A in FIG. 1A and in system 100B in FIG. 1B during ACW the agent may be given the option to provide a badge to the SME for the consultation service 301. For example, as shown in FIG. 12.

According to some embodiments of the present disclosure, checking if the provided badge is the same badge as the badge that is stored for the SME 302. If it is the same badge then, increasing the badge count 303.

According to some embodiments of the present disclosure, the badge type may be saved and its count 304.

FIG. 4 schematically illustrates a high-level workflow 400 of a computerized-method for ranking and connecting a consultant to an agent during an interaction to aid the agent in a contact center, in accordance with some embodiments of the present invention.

According to some embodiments of the present disclosure, operation 410 comprising receiving a disposition from an agent during After Call Work (ACW) of a first interaction between a first agent and a first customer, that included a consultation with a consultant from a plurality of consultants, via a User Interface (UI) that is associated to an agent application. The disposition may include rating and badging of the consultant and an associated subject-matter entered by the first customer via an Interactive Voice Response (IVR) menu.

According to some embodiments of the present disclosure, operation 420 comprising saving the rating and badging of the consultant and the associated subject-matter, in an address-book.

According to some embodiments of the present disclosure, operation 430 comprising configuring a Workforce Management (WFM) application to automatically connect in real-time a second agent with a second consultant during a second interaction with a second customer, upon the second agent user-click on a consultant-button via the UI. The second consultant is selected from the plurality of consultants in the address-book based on a highest rating for the subject-matter entered by the second customer via the IVR menu.

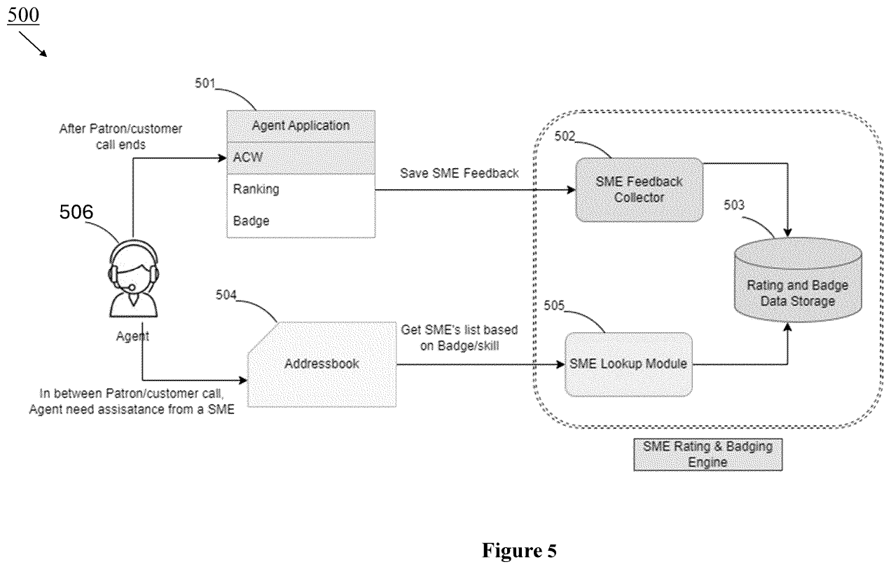

FIG. 5 schematically illustrates a high-level diagram of computerized-system 500 for ranking and connecting a consultant to an agent during an interaction to aid the agent in a contact center, in a contact center, in accordance with some embodiments of the present invention.

According to some embodiments of the present disclosure, in system 100A in FIG. 1A and in system 100B in FIG. 1B, when the agent 506 during the conversation with patron or customer involves SME for consultation, after the call ends, post completion of the consultation and wrapping up the call with patron, agent gets into ACW mode via the agent application 501. As part of this ACW state, the agent 506 may provide ranking to the service they received from the SME for the consultation and give any badge available in the system based on the skill of the SME like mortgage, credit card etc. For example, as shown in FIG. 12.

According to some embodiments of the present disclosure, an SME feedback collector 502 module may save the feedback and rating in the database, e.g., rating and badge data storage of the address-book 503 for future use.

According to some embodiments of the present disclosure, when the agent 506 is in a call with a patron and determines that consulting with the SME is necessary to address the patron's questions, the agent 506 may search for relevant skills in the address-book 504 to obtain a list of SMEs along with their ratings. The agent 506 may click on consultant button in the UI that is associated to the agent application 501 and automatically be connected via a communication channel to the highest ranked consultant in the subject-matter of the interaction as entered by the customer via the IVR menu.

According to some embodiments of the present disclosure, optionally, the agent 506 can select an SME from the list based on their ratings. The SME look up module 505 may fetch the list of SME's from the rating and badge data storage 503.

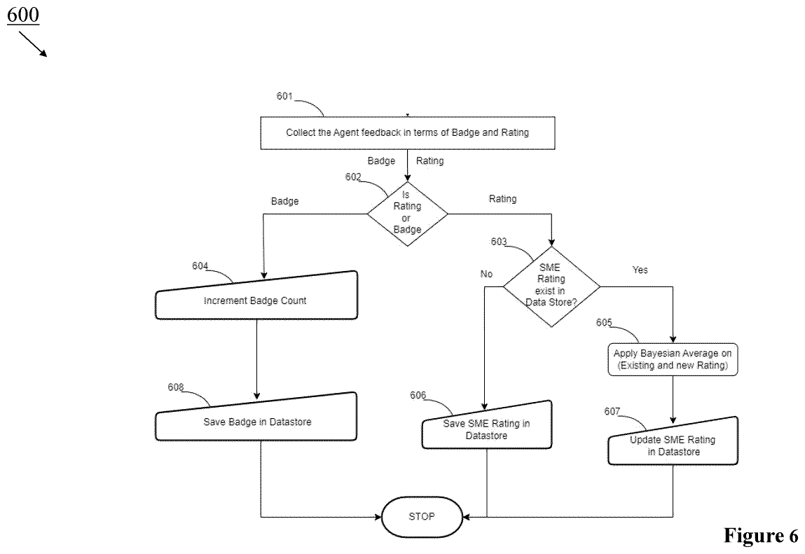

FIG. 6 schematically illustrates a high-level workflow 600 of SME feedback collector module, in a contact center, in accordance with some embodiments of the present invention.

According to some embodiments of the present disclosure, as part of the ACW the agent may provide the rating and badge to the SME depending on the agent's consultation experience with the SME. A system, such as computerized-system 100A in FIG. 1A may collect the agent's feedback in terms of badge and ratings 601.

According to some embodiments of the present disclosure, in system 100A in FIG. 1A and in system 100B in FIG. 1B, the system may check if the entered feedback is rating or a badge 602. When the feedback from the agent is a badge, the system may increase badge count 604 against the SME in the address-book and update the total count of the badge that the SME has in a datastore 608.

According to some embodiments of the present disclosure, when the feedback from the agent is rating, the system may check of the SME already has some past ratings 603. If the data storage has past rating for the SME, it applies Bayesian average algorithm on the past rating from data store and the new rating received using the formula below.

According to some embodiments of the present disclosure,

sᵢ=wᵢ·Aᵢ+(1−wᵢ)·S

whereby:
w is the weight assigned to the item's arithmetic mean A, while S denotes the System's Arithmetic Mean. If both A and S are bound, then the final score s will also be bound within the same range.

According to some embodiments of the present disclosure, the rating may be saved or updated in the data store 606, 607. Optionally, the stored rating may be leveraged by: (i) Workforce Management (WFM) application for better staffing of agents and the SMEs, (ii) reporting, and (iii) Quality Management (QM) purposes detect how frequently the agents are required to reach out to SMEs in a day-to-day shift.

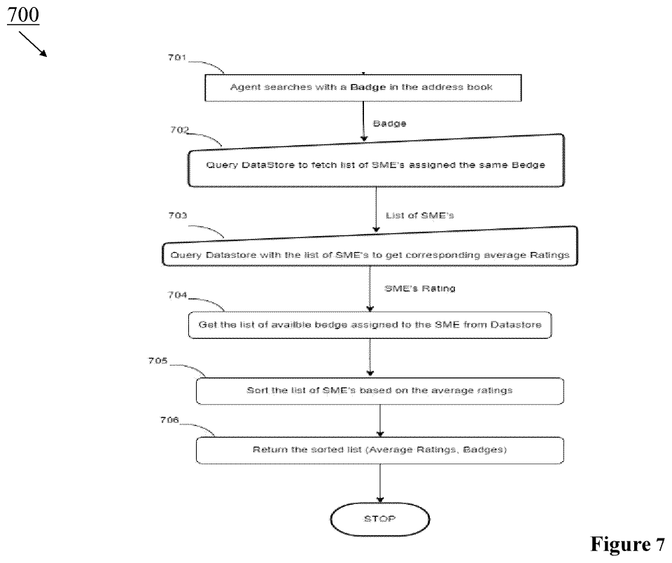

FIG. 7 schematically illustrates a high-level workflow 700 of SME lookup module, in a contact center, in accordance with some embodiments of the present invention.

According to some embodiments of the present disclosure, in a system, such as system 100A in FIG. 1A and such as system 100B in FIG. 1B, when the agent is in a call with a customer and the agent requires an SME for consultation, the agent searches the badge, for example, for Home lending consultation, the agent searches badge as home lending, for credit card consultation badge would be credit card and the like, in the address-book 701.

According to some embodiments of the present disclosure, the system may query the data store with the input badge and may get the list of all SME's tagged to the badge 702.

According to some embodiments of the present disclosure, the system may use the list of SMEs to get the corresponding average ratings 703 stored and all the badges assigned from the data store.

According to some embodiments of the present disclosure, get the list of available badge assigned to the SME from the data store 704 of the address-book and then sort the list of SMEs based on the average rating 705 and return the sorted list of consultant and the corresponding average rating and badges 706 to the address-book UI.

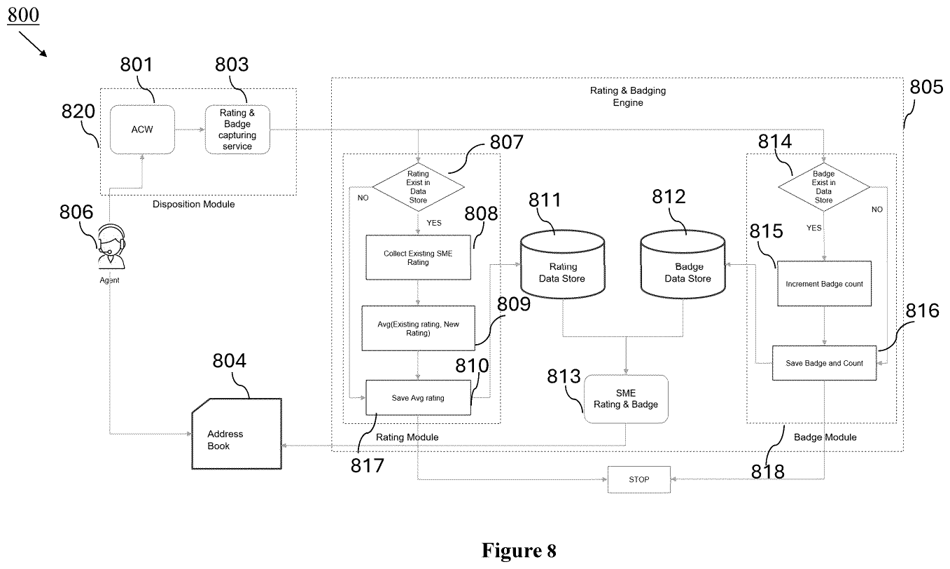

FIG. 8 schematically illustrates a high-level diagram of computerized-system 800 for ranking and connecting a consultant to an agent during an interaction to aid the agent in a contact center, in a contact center, in accordance with some embodiments of the present invention.

According to some embodiments of the present disclosure, the agent 806 during the conversation with patron or customer may involve SME for consultation. Post completion of the consultation and wrapping up the call with patron, agent gets into ACW mode which is operated by a disposition module 820. The purpose of ACW is to wrap up the call and update the case or fill up the disposition form and if needed create a task to follow up. As part of this ACW state, agent will be given an option to update the ranking and badge of the consultant for the service they received from the SME for the consultation. The feedback from the agent may be captured by a rating and badge capturing service 803.

According to some embodiments of the present disclosure, the rating and badge capturing service may forward the feedback to a rating and badging engine 805 that may operate a rating module 817 to calculate the rating and store it in a rating data store 811 and a badge module 818 to calculate the badge and its count and store it in a badge data store 812.

According to some embodiments of the present disclosure, the rating module 817 may check if the received rating exists in the data store 807. If it exists, then the rating module 817 may collect existing SME rating 808 and calculate an average of the existing rating and the received rating 809 and save it in the rating data store 811.

According to some embodiments of the present disclosure, the badge module may check if the received badge exists in the badge data store 814 and if it exists then the badge module 818 may increment the badge count 815 and then save the badge and the count 816.

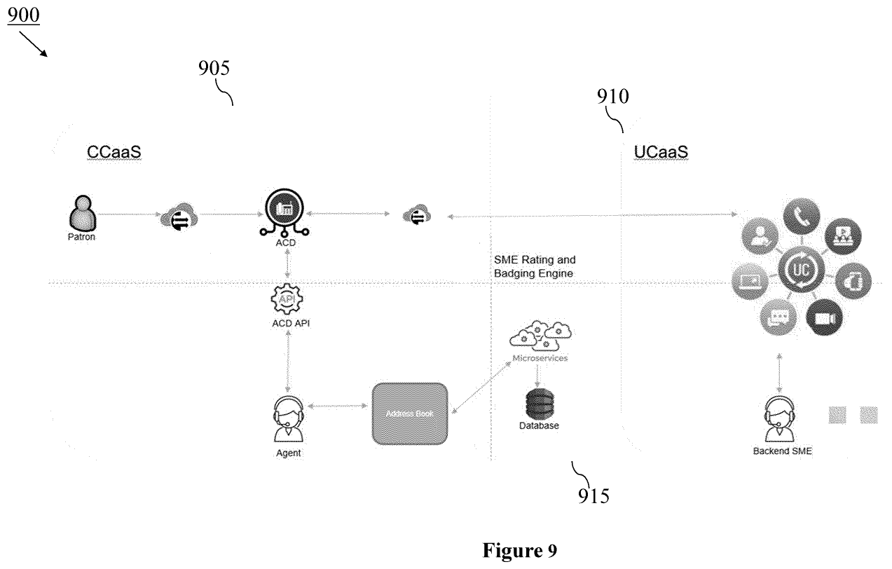

FIG. 9 schematically illustrates a hardware architecture of computerized-system 900 for ranking and connecting a consultant to an agent during an interaction to aid the agent in a contact center, in accordance with some embodiments of the present invention.

According to some embodiments of the present disclosure, a customer may contact Contact Center as a Service (CCaaS) 905 and may be routed via Automatic Calls Distributor (ACD) application to an agent. During the interaction with the customer the agent may wish to consult with a consultant related to a subject-matter. The agent may click on a button in the UI associated to the agent application and may be automatically connected to highest rated SME in the address-book in the subject matter as saved in the database 915.

According to some embodiments of the present disclosure, the internal communication with the selected SME may be streamlined by the Unified Communications as a Service (UCaaS) 910.

FIG. 10 is a screenshot 1000 of a UI page of an agent application for ranking and badging a consultant, in a contact center in accordance with some embodiments of the present invention.

According to some embodiments of the present disclosure, in a system, such as system 100A, and such as system 100B in FIG. 1B, the agent may rate a consultant for the quality of consultation the agent has received 1005 and the agent may award a badge for the SME's expertise 1010.

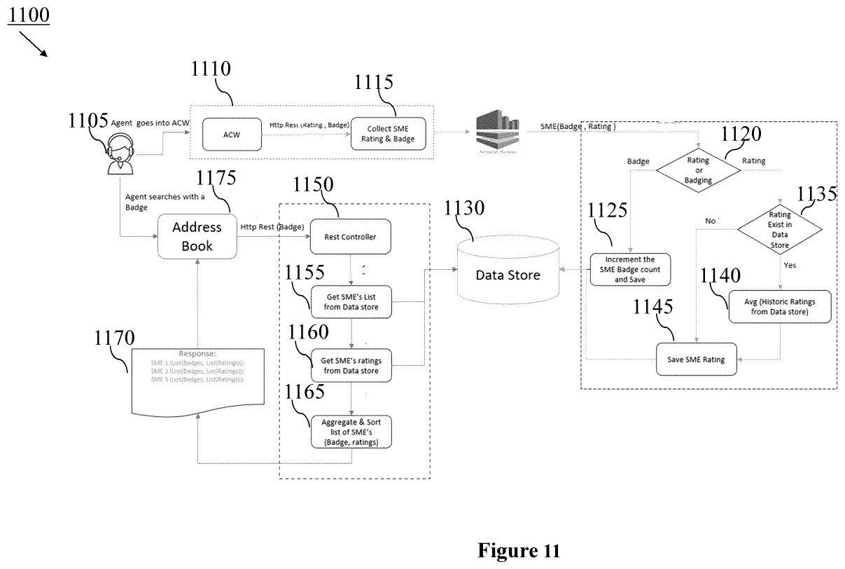

FIG. 11 schematically illustrates a software architecture 1100 of computerized-system for ranking and connecting a consultant to an agent during an interaction to aid the agent in a contact center, in accordance with some embodiments of the present invention.

According to some embodiments of the present disclosure, in a system, such as system 100A, and such as system 100B in FIG. 1B, after the agent 1105 ends the call with a customer, the agent 1105 goes into ACW 1110 state and would be providing ranking to the service they received from the SME for the consultation, and give any badge available in the system.

According to some embodiments of the present disclosure, the system may collect the ranking and badge and push the data into a real-time data streaming and processing, such as Amazon® Web Service (AWS) Kinesis.

According to some embodiments of the present disclosure, checking if the feedback from the agent is rating or badging 1120 and when it is rating then checking if the rating exists in data store 1135 and if it exists calculating the average of the historic rating and the newly provided rating 1140, for example, by using Bayesian average. Then saving the SME rating 1145 in the datastore 1130. When the feedback is a badge, incrementing the SME badge count and saving and saving in the datastore 1130.

According to some embodiments of the present disclosure, when the agent 1105 may require assistance of a consultant the agent may either click on a button in the agent application to automatically connect or search in the address-book 1175 for an SME with a badge and rating in the subject matter. Suppose the agent needs to consult an SME for home Lending, then the agent would search with home lending badge in the address-book 1175.

According to some embodiments of the present disclosure, the searching request may reach the controller 1150 and SME's list may be fetched from the data store 1130 corresponding to the badge provided in the search request 1160 and then aggregate and sort the list of SME's badge and rating 1165. The sorted list of SMEs may be displayed via the address-book UI.

FIG. 12 is a screenshot of a UI page 1200 of an agent application with ranking and badging of a consultant, in a contact center, in accordance with some embodiments of the present invention.

According to some embodiments of the present disclosure, UI page 1200 shows a list of SMEs with related rating and badges which may be presented to an agent when the agent is looking for a consultant, in a system, such as system 100A in FIG. 1A, and such as system 100B in FIG. 1B.

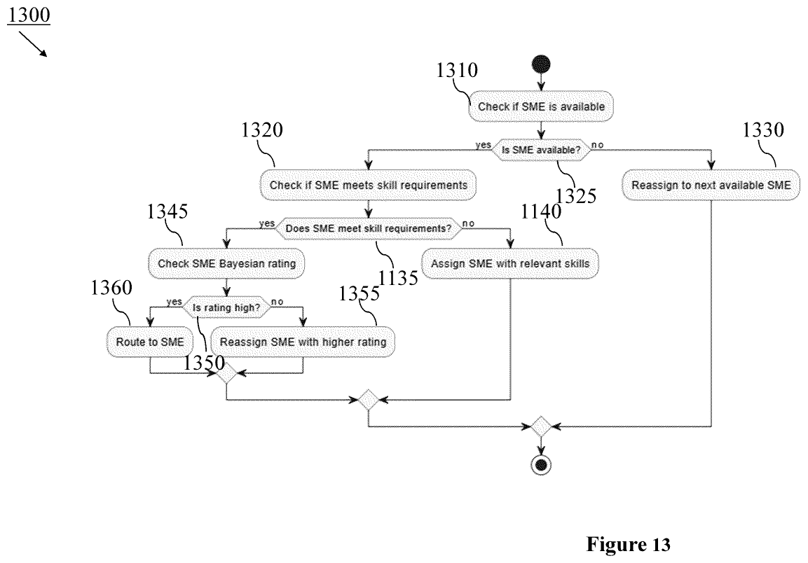

FIG. 13 schematically illustrates a high-level workflow 1300 of ACD routing based on ranking and badging of a consultant, in accordance with some embodiments of the present invention.

According to some embodiments of the present disclosure, the rating and badging of system 100A in FIG. 1A and system 100B in FIG. 1B may be used to optimize the routing of an Automatic Call Distributor (ACD) application. High-rated SMEs may be prioritized when an agent clicks on the consultant button during the interaction for assistance in a subject-matter. When there are multiple choices of available SMEs, the system may automatically route in real-time the request to the highest-rated SME based on the relevant expertise.

According to some embodiments of the present disclosure, the system may check if an SME is available 1310 and if the SME is available the system may check if SME meets skill requirement to the subject-matter of the ongoing interaction. When the SME meets the skill requirement, the system may check the rating of the SME, by checking the SME Baysian rating 1345. When the rating is highest of all SMEs for the subject matter then the agent may be connected to the SME 1360 for consultation.

According to some embodiments of the present disclosure, the system may apply a dynamic availability adjustment such that SMEs with lower rating may receive fewer consultation requests until their rating improves, ensuring that the agent interact with most effective SMEs.

According to some embodiments of the present disclosure, the system may implement an escalation management by configuring the ACD to prompt an escalation to higher-rated SME, when the agent consults a low-ranked SME and does not receive a satisfactory consultation or response. This may ensure that the unresolved queries are handled effectively.

According to some embodiments of the present disclosure, the rating and badging of the SME may improve the quality of SME consultations by prioritizing high-performing SMEs, reduce agent frustration by ensuring they receive the best possible assistance and enhance overall customer satisfaction by enabling agents to resolve issues faster.

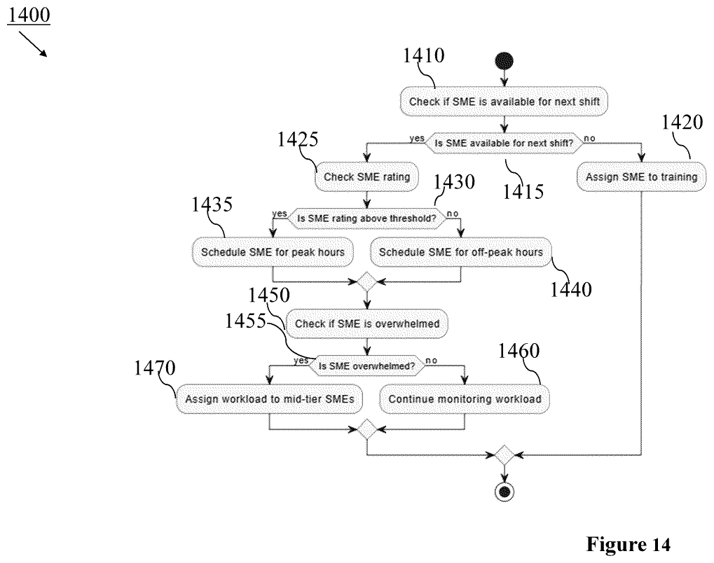

FIG. 14 schematically illustrates a high-level workflow 1400 of WFM scheduling based on ranking and badging of a consultant, in accordance with some embodiments of the present invention.

According to some embodiments of the present disclosure, the rating and badging of system 100A in FIG. 1A and system 100B in FIG. 1B may be used to enhance the Workforce Management (WFM) application.

According to some embodiments of the present disclosure, SME rankings can influence the time of day of shifts when the SMEs are scheduled. High-rated SMEs can be scheduled during peak hours to maximize their impact, while lower-rated SMEs can be assigned to training sessions.

According to some embodiments of the present disclosure, SME rankings may dynamically balance workload such that when a highly rated SME is overwhelmed with requests, the WFM system can distribute some consultations to mid-tier SMEs, preventing SMEs burnout while maintaining quality.

According to some embodiments of the present disclosure, SME rankings may optimize the shift when a workforce planner uses the SME rating to determine optimal staffing for specific shifts, ensuring a balanced mix of expertise levels. The WFM application may be optimized by optimizing SME allocation which would help reduce bottlenecks and underutilization of staff, improving efficiency in handling consultation requests and proactive workforce planning by identifying top-performing SMEs for critical shifts.

According to some embodiments of the present disclosure, the WFM application may be configured to check if SME is available for the next shift 1410, if the SME is available for next shift, then checking the SME rating 1425. Checking if SME rating is above a threshold 1430, if it is above the threshold the WFM application may be configured to schedule the SME for peak hours 1435 and otherwise for off-peak hours 1440. Then, checking if SME is overwhelmed 1450 and if the SME is overwhelmed assigning workload to mis-tier SMEs 1470, otherwise continuing to monitor workload 1460.

According to some embodiments of the present disclosure, when the SME is not available for next shift, assigning SME to training 1420 to train the SME for the missing skill that caused the SME unavailability.

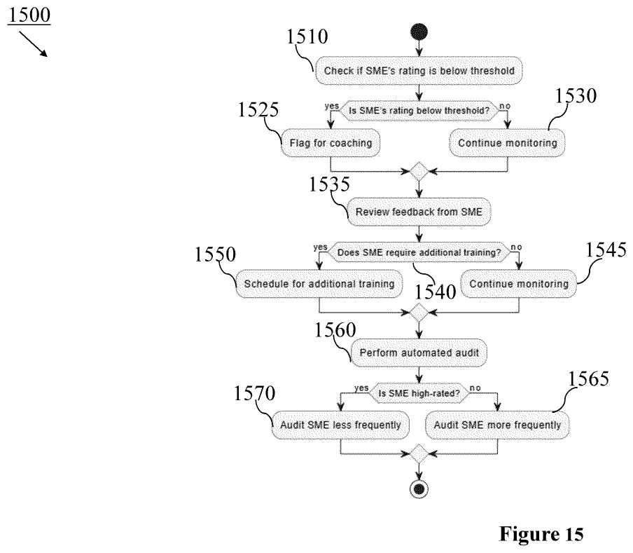

FIG. 15 schematically illustrates a high-level workflow 1500 of QM application filtering of interactions based on ranking and badging of a consultant, in accordance with some embodiments of the present invention.

According to some embodiments of the present disclosure, the rating and badging of system 100A in FIG. 1A and system 100B in FIG. 1B may enhance the performance of the Quality Management (QM) application.

According to some embodiments of the present disclosure, lower-rated SMEs may be flagged for additional coaching or quality improvement plans based on consultation feedback and Bayesian ratings.

According to some embodiments of the present disclosure, high-rated SMEs may be sampled less frequently for audits, while lower-rated SMEs may be reviewed more often to identify improvement areas.

According to some embodiments of the present disclosure, when an SME's rating drops below a certain threshold, the QM application may trigger an alert to supervisors, prompting a review of their recent interactions. The QM application may ensure the SMEs consistently provide high-quality support. The QM application may reduce manual intervention by automating coaching and audit triggers. The QM application may enhance SME development by aligning training efforts with performance data.

According to some embodiments of the present disclosure, the QM application may be configured to check if SME's rating is below threshold 1510 and if it is flag for coaching 1525 or otherwise continue monitoring 1530. Then review feedback from SME 1535 and check if the SME requires additional training 1540. If the SME requires additional training, the QM application may schedule for additional training 1550, otherwise continue monitoring 1545.

According to some embodiments of the present disclosure, the QM application may perform automated audit 1560 and check if SME high-rated. If the SME is high-rated, e.g., above a preconfigured threshold then audit SME less frequently 1570, otherwise audit SME more frequently 1565.

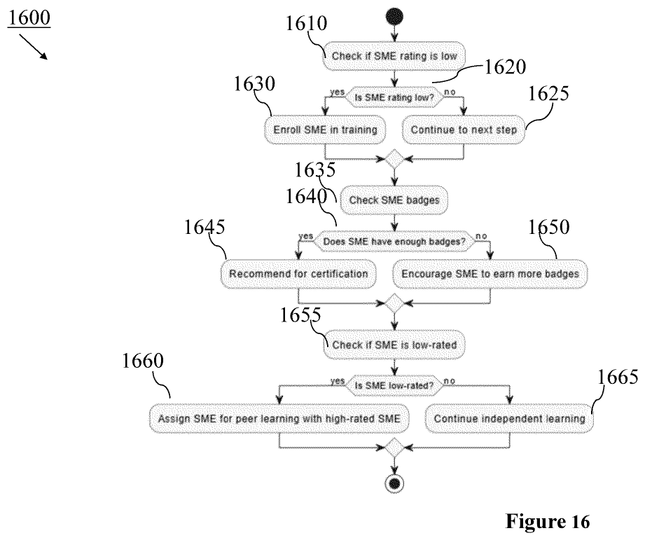

FIG. 16 schematically illustrates a high-level workflow 1600 of learning and development based on ranking and badging of a consultant, in accordance with some embodiments of the present invention.

According to some embodiments of the present disclosure, the rating and badging of system 100A in FIG. 1A and system 100B in FIG. 1B may automate the learning and development process by having SMEs with lower ratings automatically enrolled in targeted training programs to improve their skills.

According to some embodiments of the present disclosure, when an SME receives a high number of skill-specific badges, they may be automatically recommended for leadership or advanced certification programs.

According to some embodiments of the present disclosure, lower-rated SMEs may be paired with higher-rated SMEs for mentorship and knowledge-sharing sessions which may accelerate skill development among SMEs, encourage a continuous learning culture in the call center, and help in identifying and grooming future SME leaders.

According to some embodiments of the present disclosure, the learning and development process may be configured to check if SME rating is low 1610. If the SME rating is low enroll SME in training 1630 or otherwise continue to next step 1625. Then, check SME badges, if SME have enough badges 1640, e.g., above a preconfigured threshold, then recommend for certification 1645 or otherwise encourage SME to earn more badges 1650 and then check if SME is low-rated 1655 and if the SME is low-rated, assign SME for peer training with high-rated SME 1660 or otherwise continue independent learning 1665.

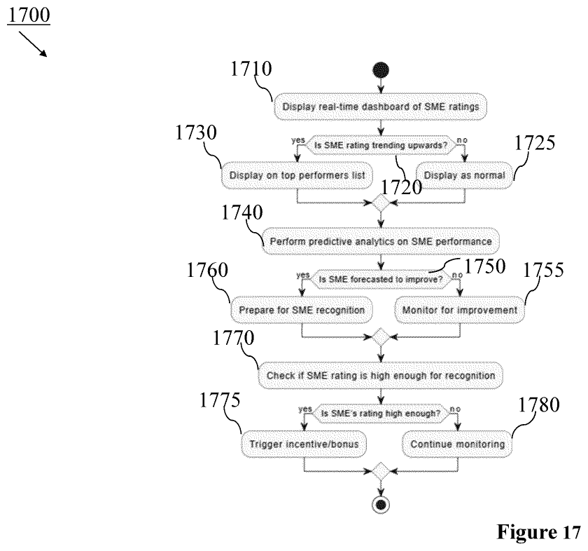

FIG. 17 schematically illustrates a high-level workflow 1700 of performance analytics and reporting based on ranking and badging of a consultant, in accordance with some embodiments of the present invention.

According to some embodiments of the present disclosure, in a system, such as system 100A in FIG. 1A and system 100B in FIG. 1B performance analytics and reporting may be based on ranking and badging of a consultant. Supervisors can get real-time insights into SME rankings and badging trends, helping them make data-driven decisions.

According to some embodiments of the present disclosure, historical data on ratings and badges can be used to predict future performance trends, enabling proactive workforce planning. High-rated SMEs can be automatically recognized with incentives, bonuses, or leaderboard placements to maintain motivation and engagement.

According to some embodiments of the present disclosure, ranking and badging of a consultant may provide a data-driven approach to SME performance management, encourage competition and motivation among SMEs and help leadership make strategic decisions based on real-time SME performance data.

According to some embodiments of the present disclosure, the performance analytics and reporting process may be configured to display real-time dashboard of SME ratings 1710 and then check if SME rating is trending upwards 1720. If the SME rating is trending upwards, display on top performance list 1730 or otherwise display as normal 1725. Them perform predictive analytics on SME performance 1740 and check if SME forecasted to improve 1750. If the SME is forecasted to improve, prepare for SME recognition 1760 or otherwise monitor for improvement 1755.

According to some embodiments of the present disclosure, then, check if SME rating is high enough for recognition 1770, e.g., above a preconfigured threshold, if the SME rating if high-enough triggering incentive or bonus 1775 or otherwise continue monitoring 1780.

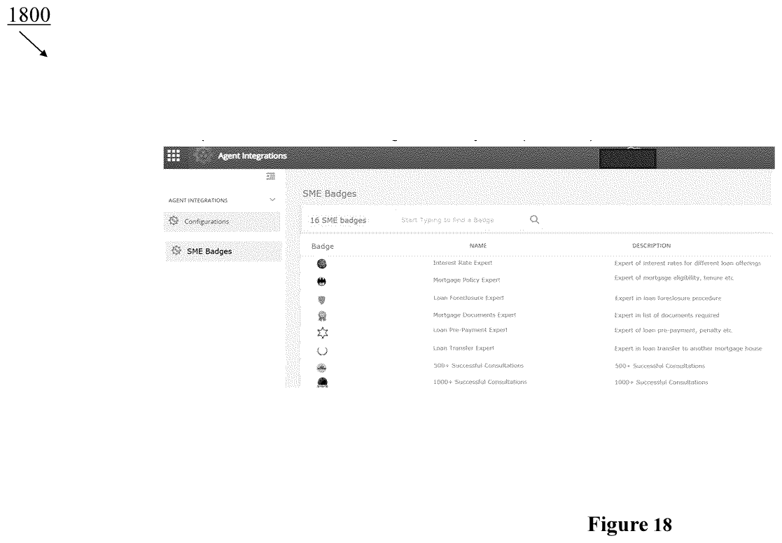

FIG. 18 is a screenshot of a UI page 1800 of an agent application with badging of consultants, in a contact center, in accordance with some embodiments of the present invention.

According to some embodiments of the present disclosure, UI page 1800 shows a list of badges that may be given to a consultant for a consultation service by an agent in a system, such as system 100A in FIG. 1A, and such as system 100B in FIG. 1B.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for ranking and connecting a consultant to an agent during an interaction to aid the agent in a contact center, said computerized-method comprising:
(i) receiving a disposition from a first agent during After Call Work (ACW) of the first interaction between a first agent and a first customer, that included a consultation with a consultant from a plurality of consultants, via a User Interface (UI) that is associated to an agent application,
wherein the disposition is comprising rating and badging of the consultant and an associated subject-matter entered by the first customer via an Interactive Voice Response (IVR) menu;
(ii) saving the rating and badging of the consultant and the associated subject-matter, in an address-book; and
(iii) configuring a Workforce Management (WFM) application to automatically connect in real-time a second agent with a second consultant during a second interaction with a second customer, upon the second agent user-click on a consultant-button via the UI,
wherein the second consultant is selected from the plurality of consultants in the address-book based on a highest rating for the subject-matter entered by the second customer via the IVR menu.

2. The computerized-method of claim 1, wherein the rating is based on a skill set of the consultant and wherein the skill set is related to the entered subject-matter.

3. The computerized-method of claim 1, wherein the rating of the consultant is captured by a rating and badging capturing service.

4. The computerized-method of claim 1, wherein the saving of the rating and badging of the consultant comprising operating a rating module and a badge module.

5. The computerized-method of claim 1, wherein the WFM application is scheduling consultants having the rating above a first preconfigured rate-threshold during forecasted time-slots with volume above a preconfigured volume-threshold.

6. The computerized-method of claim 1, wherein consultants having the rating below a second rate-threshold are automatically assigned to a training session.

7. The computerized-method of claim 1, wherein the computerized-method is further comprising configuring a Quality Management (QM) application to sample interactions for audit based on the rating of the consultant.

8. A computerized-system for ranking and connecting a consultant to an agent during an interaction to aid the agent in contact center, said computerized-system comprising:
a User Interface (UI) associated to an agent application;
an Interactive Voice Response (IVR) menu;
an address-book of a plurality of consultants;
a memory to store the address-book; and
one or more processors, said one or more processors are configured to:
(i) receive a disposition from an agent during After Call Work (ACW) of a first interaction
between a first agent and a first customer, that included a consultation with a consultant from a plurality of consultants, via the UI that is associated to the agent application,
wherein the disposition is comprising rating and badging of the consultant and an associated subject-matter entered by the first customer via an Interactive voice response (IVR) menu;
(ii) saving the rating and badging of the consultant and the associated subject-matter, in the address-book; and
(iii) configuring a Workforce Management (WFM) application to automatically connect in real-time a second agent with a second consultant during a second interaction with a second customer, upon the second agent user-click on a consultant-button via the UI,
wherein the second consultant is selected from the plurality of consultants in the address-book based on a highest rating for the subject-matter entered by the second customer via the IVR menu.
